(19) United States
(12) Patent Application Publication
(10) Pub. No.: US 2007/0211200 A1
(43) Pub. Date: Sep. 13, 2007

(54) Liquid crystal display device and method for manufacturing the same

(76) Inventors: Han-ju Lee, Gyeonggi-do (KR); Young-eui Lee, Gyeonggi-do (KR); Kook-hyun Choi, Gyeonggi-do (KR); Myung-il Park, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/701,882

(22) Filed: Feb. 2, 2007

(30) Foreign Application Priority Data
Feb. 3, 2006 (KR) 10-2006-0010811

(51) Int. Cl. G02F 1/1343

(52) U.S. Cl. 349/139

(57) ABSTRACT

A liquid crystal display device includes a thin film transistor substrate comprising a plurality of thin film transistors and a plurality of pixel electrodes electrically connected to the plurality of thin film transistors, respectively, to receive a pixel voltage, the pixel electrodes being formed in a pixel region. A second substrate comprising a plurality of sub-common electrodes is positioned in an opposing relationship to the thin film transistor substrate. The sub-common electrodes are positioned opposite the pixel electrodes. A liquid crystal layer interposed between the thin film transistor and the second substrate.

### CROSS-REFERENCE TO RELATED APPLICATIONS

This application claims the benefit of Korean Patent Application No. 10-2006-0010811, filed on Feb. 3, 2006, in the Korean Intellectual Property Office, the disclosure of which is incorporated herein by reference in its entirety.

### BACKGROUND OF THE INVENTION

1. Field of the Invention

The present invention relates to a liquid crystal display device and a method for manufacturing the same, and more particularly, to a liquid crystal display device with pixel electrodes and a common electrode for applying a voltage to a liquid crystal layer, and a method for manufacturing the same.

2. Description of the Related Art

A liquid crystal display (LCD) device includes an LCD panel comprising a thin film transistor (TFT) substrate on which TFTs and pixel electrodes for pixels are formed, an opposing substrate on which one common electrode is formed, and a liquid crystal layer located between both substrates. Since the LCD panel does not itself generate light, a backlight unit is positioned in the rear of the TFT substrate so as to provide light to the LCD panel.

In the LCD device, the alignment of molecules at a pixel in the liquid crystal layer may depend on a voltage difference between a pixel electrode for the pixel and the common electrode. As the alignment of molecules in the liquid crystal layer is varied, the amount of transmission of light emitted from the backlight unit and passing through each pixel is adjusted to allow a desired image to be displayed on a screen.

In manufacturing the LCD device, it is checked whether or not the LCD panel contains any defective pixels for every step. As an example of methods for repairing a defective pixel found when the LCD panel is checked after the backlight unit is assembled in the rear of the LCD panel, there is a method for cutting at least one of a source electrode and a drain electrode of the defective pixel, which apply a pixel voltage to the defective pixel, using a laser beam. When at least one of the source electrode and the drain electrode of the defective pixel is cut by the laser beam, the pixel voltage can not be applied to the pixel electrode. An LCD device having a normally black mode and not requiring high display performance has no significant problem even when the repaired defective pixel always displays a black image when there is no application of the pixel voltage and the common voltage to the repaired pixel.

However, the above-mentioned repair method requires a process of disassembling the backlight unit from the LCD panel in order to cut at least one of the source electrode and the drain electrode formed on the TFT substrate with no effect on a color filter substrate and the liquid crystal layer. Moreover, since the backlight unit has to be recombined with the LCD panel after the at least one of the source electrode and the drain electrode is cut by laser beam irradiation of the TFT substrate, this method has a problem in that it takes considerable time to repair the LCD panel and lowers the efficiency of LCD production.

### SUMMARY OF THE INVENTION

According to one aspect of the present invention, an LCD panel is provided in which defective pixels can be deactivated without difficulty, and a method of manufacturing the same is provided.

One aspect of the present invention is achieved by a liquid crystal display device comprising a thin film transistor substrate comprising a plurality of thin film transistors and a plurality of pixel electrodes electrically connected to the plurality of thin film transistors, respectively, to receive a pixel voltage, the pixel electrodes being formed in a pixel region; an opposite substrate comprising a plurality of sub-common electrodes formed corresponding to the pixel electrodes, the sub-common electrodes being supplied with a common voltage, and a plurality of connecting parts interconnecting the plurality of sub-common electrodes; and a liquid crystal layer interposed between the thin film transistor and the opposite substrate.

The liquid crystal display device may include common voltage lines formed in the form of a lattice between the sub-common electrodes.

The sub-common electrodes, the connecting parts, and the common voltage lines may be integrally formed for the sake of convenience of manufacture.

The connecting parts interconnect the plurality of sub-common electrodes by connecting the sub-common electrodes to the common voltage lines. Alternatively, the common voltage lines are not included and the connecting parts connect sub-common electrodes to adjacent sub-common electrodes.

The sub-common electrodes have a rectangular shape, and the connecting parts are connected to at least one of corners and vertexes of the sub-common electrodes.

The liquid crystal layer has a vertically aligned (VA) mode.

Domain-defining members are formed in the sub-common electrodes and the pixel electrode.

The liquid crystal display device has a normally black mode under no application of the pixel voltage and the common voltage in order to maintain constant display performance after defective pixels are deactivated.

In accordance with one embodiment of the present invention a method for manufacturing a liquid crystal display device is provided. The method comprises providing a first thin film transistor substrate comprising a plurality of thin film transistors and a plurality of pixel electrodes electrically connected to the plurality of thin film transistors, respectively, the pixel electrodes being formed in a pixel region. The method further comprises providing a second substrate, including a common electrode comprised of a plurality of sub-common electrodes positioned to correspond to associated ones of the pixel electrodes, and a plurality of connecting parts interconnecting the plurality of sub-common electrodes and providing a liquid crystal display panel by bonding the first thin film transistor substrate to the second substrate and filling a space formed between the first thin film transistor substrate and filling a space formed between the first thin film transistor substrate and the second substrate with a liquid crystal layer.

The sub-common electrodes are formed by depositing a transparent conductive layer; and patterning the transparent conductive layer using a photolithographic process for the sake of convenience of manufacture.

In one embodiment of the method, the common electrode further comprises a plurality of common voltage lines and predetermined ones of the connecting parts connect sub-common electrodes to adjacent common voltage lines, the common voltage lines having a lattice shape and being interposed between the sub-common electrodes, are simultaneously formed.

The sub-common electrodes have a rectangular shape, and the connecting parts are connected to at least one of corners and vertexes or along a side of the sub-common electrode of the sub-common electrodes in order to smoothly apply the common voltage to the sub-common electrodes.

The liquid crystal layer has a vertically aligned (VA) mode.

A domain-defining member is formed in the common electrodes through the patterning.

The providing of the first thin film transistor substrate may comprise forming domain-defining members in the pixel electrodes corresponding to the common electrodes.

The method further comprises, after the providing the liquid crystal display panel, checking whether the liquid crystal display panel has defective pixels.

The method further comprising if a defective pixel is found in the checking cutting the connecting parts connected to the sub-common electrode corresponding to the defective pixel.

The defective pixels in the liquid crystal display panel appear as only black images in order to maintain display performance.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 shows a layout of a TFT substrate of an LCD device according to a first embodiment of the present invention;

FIG. 2 shows a layout of a second substrate of the LCD device according to the first embodiment of the present invention;

FIG. 3 is a sectional view of an LCD panel of the LCD device, taken along line III-III of FIGS. 1 and 2;

FIGS. 4A to 4C and 4D are sectional views and a layout for illustrating a method of manufacturing the opposite substrate of the LCD device, respectively, according to the first embodiment of the present invention; and

FIGS. 5 and 6 show layouts of a second substrate for an LCD device according to a second embodiment and a third embodiment of the present invention, respectively.

### DETAILED DESCRIPTION OF THE PREFERRED EMBODIMENT

Reference will now be made in detail to exemplary embodiments in accordance with the present invention, examples of which are illustrated in the accompanying drawings.

In the following embodiments, the like elements will be described for a first exemplary embodiment and may not be further described for other embodiments. In the following description, the term ‘on’ or ‘above’ means that not only a first layer (film) lies immediately on a second layer (film) but also the first layer (film) lies on the second layer (film) with a third layer (film) interposed between the first and second layers (films).

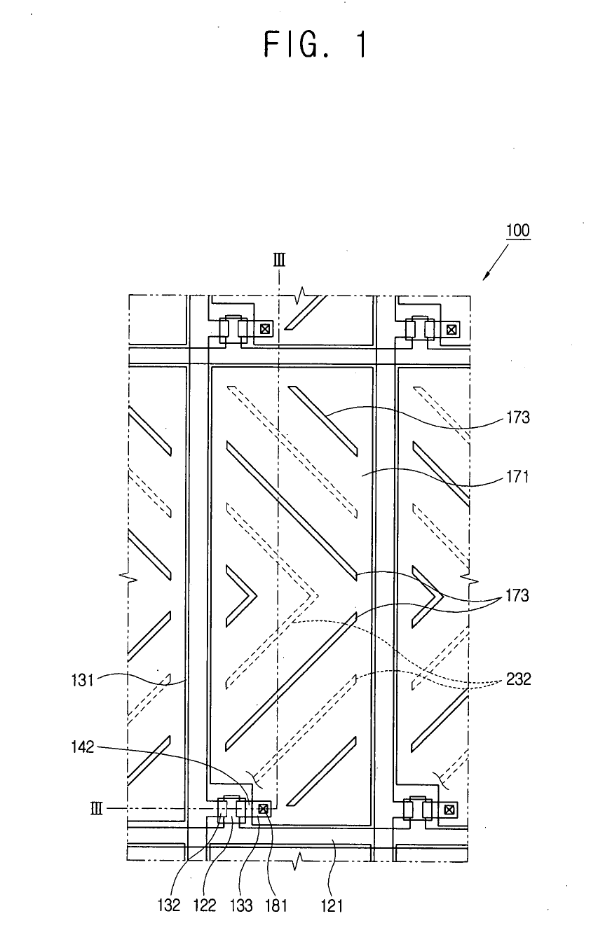

An LCD device according to a first embodiment of the present invention is described below with reference to FIGS. 1 to 3.

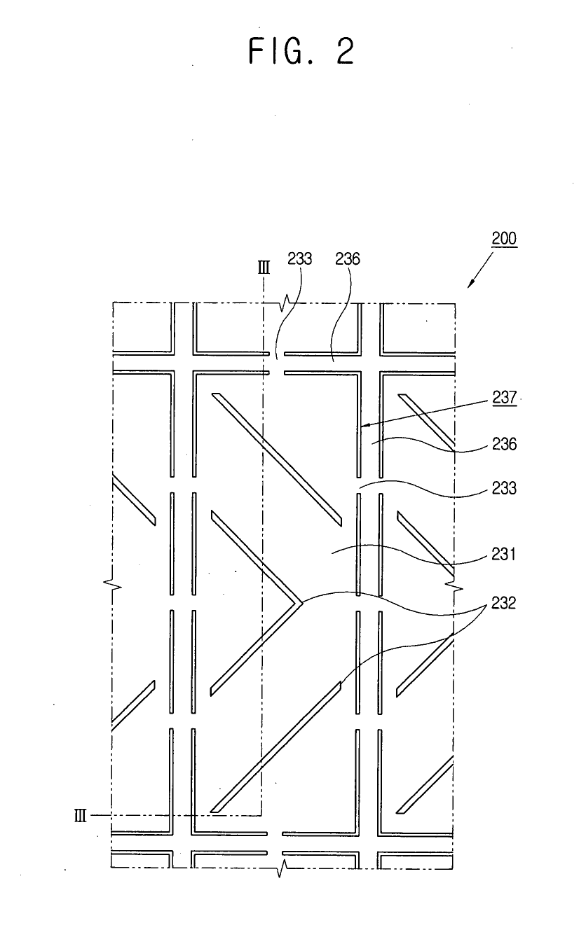

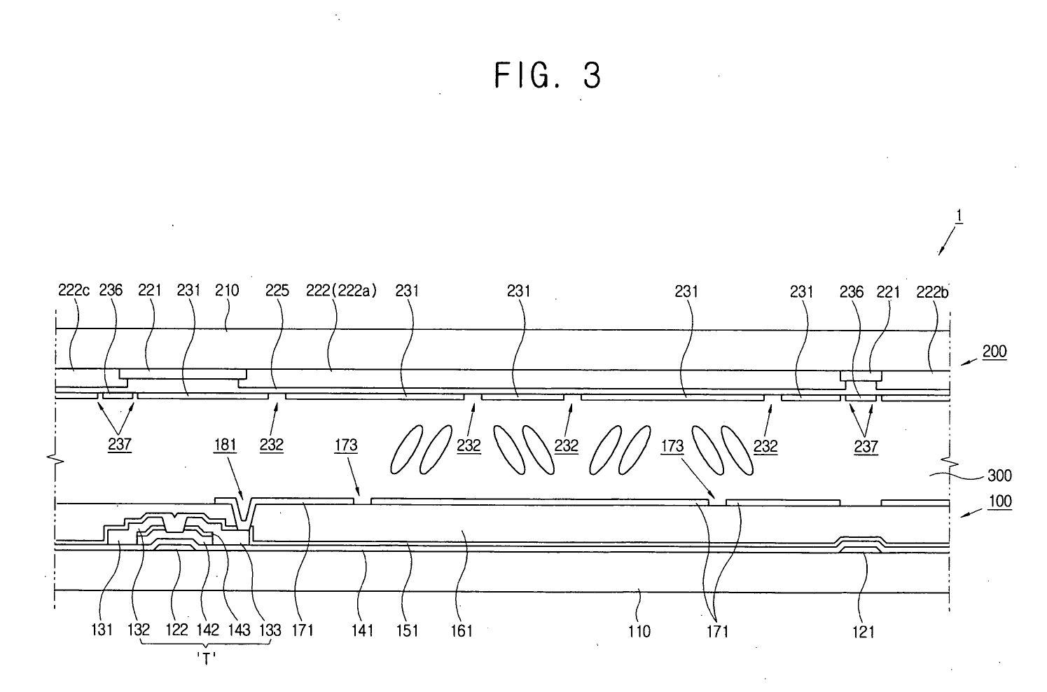

FIG. 1 shows a layout of a TFT substrate of an LCD device according to a first embodiment of the present invention, FIG. 2 shows a layout of an opposite substrate of the LCD device according to the first embodiment of the present invention, and FIG. 3 is a sectional view of an LCD panel of the LCD device, taken along line III-III of FIGS. 1 and 2.

The LCD according to the first embodiment of the present invention includes an LCD panel 1 on which an image is formed and a backlight unit (not shown) disposed in the rear of the LCD panel 1 for providing light to the LCD panel 1. The backlight unit is known in the art, and therefore, detailed explanation thereof will be omitted and the following description centers on the LCD panel 1.

The LCD panel 1 includes a TFT substrate 100, an opposite substrate 200, and a liquid crystal layer 300 disposed between both substrates 100 and 200.

To begin with, the TFT substrate 100 will be described in detail.

Gate wiring lines 121 and 122 are formed on a first insulating substrate 110. The gate wiring lines 121 and 122 may be provided as a single metal layer or multiple metal layers. The gate wiring lines 121 and 122 include a longitudinally extending gate line 121 and a gate electrode 122 of a TFT T connected to the gate line 121.

A gate insulating film 141 made of silicon nitride (SiNx) or the like covers the gate wiring lines 121 and 122 on the first insulating substrate 110.

A semiconductor layer 142 made of a semiconductor material such as amorphous silicon or the like is formed on the gate insulating film 141 of the gate electrode 122. On the semiconductor layer 142 is formed an ohmic contact layer 143 made of such material as n+ hydrogenated amorphous silicon with heavily doped n-type impurities. The ohmic contact layer 143 is divided into two parts around the gate electrode 122.

Data wiring lines 131, 132 and 133 are formed on the ohmic contact layer 143 and the gate insulating film 141. The data wiring lines 131, 132 and 133 may also be provided as a single metal layer or multiple metal layers. The data wiring lines 131, 132 and 133 include a data line 131 formed perpendicular to the gate line 121, with a pixel defined by the data line 131 and the gate line 121; a source electrode 132, which is a branch of the data line 131, extending to the top of the ohmic contact layer 143; and a drain electrode 133 separated from the source electrode 132 and formed on the opposite side to the source electrode 132 around the gate electrode 122.

The TFT T is formed to include the gate electrode 122, the semiconductor layer 142, the ohmic contact layer 143, the source electrode 132, and the drain electrode 133.

A passivation film 151 made of the same material as the gate insulating film 141, for example, silicon nitride or the like, is formed on the data wiring lines 131, 132 and 133 and a portion of the semiconductor layer 142, which is not covered with the data wiring lines 131, 132 and 133. In the passivation film 151 is formed a drain contact hole 181 exposing the drain electrode 143.

An organic film 161 and a pixel electrode 171 are formed on the passivation film 151. The organic film 161 contains one of benzocyclobutene and acryl resin, which are photosensitive material, and is removed from the drain contact hole 181 as in the passivation film 151.

The pixel electrode 171 is typically made of such transparent conductive material as ITO (indium tin oxide) or IZO (indium zinc oxide). The pixel electrode 171 contacts with the drain electrode 133 via the drain contact hole 181 that passes through the organic film 161 and the passivation film 151. A pixel electrode domain-defining members 173 is formed in the pixel electrode 171. The pixel electrode domain-defining member 173 is formed in a pixel region to divide the liquid crystal layer 300 into a plurality of domains together with a common electrode domain defining member 232, which will be described later.

The second substrate 200 which is positioned opposite the first substrate 100 is described below.

Black matrices 221 are formed on a second insulating substrate 210. The black matrices 221 are positioned between color filters 222a, 222b and 222c in red, green and blue and serve to prevent light from being directly irradiated on the TFT T formed on the TFT substrate 100. The black matricies 221 are made of a photosensitive organic material that contains black pigment such as carbon black or titanium oxide.

The color filters 222a, 222b and 222c, red, green and blue, respectively, are formed on the second insulating substrate 210, partially overlapping with the black matrices 221. Color filters 222a, 222b and 222c are patterned on the second insulating substrate 210, with the black matricies 221 interposed as boundaries therebetween. The color filters are typically made of a photosensitive organic material and serves to give a color to light emitted from the backlight unit and passed through the liquid crystal layer 300.

An overcoat layer 225 is formed on the color filters and a portion of the black matricies 221, which is not covered with the color filters. The overcoat layer 225 serves to planarize and protect the color filters 222 and is typically made of an acryl epoxy material.

Common voltage wiring line electrode portions 231, 233 and 236 are formed on the overcoat layer 225. The common voltage wiring lines include a plurality of sub-common electrodes 231 which are separated from each other. Each sub-common electrode 231 has an associated pixel electrode 171. Common voltage line portion 236 provides a common voltage to the sub-common electrodes 231; and a connecting part 233 provides the-common voltage from the common voltage line portion 236 to the sub-common electrodes 231.

The plurality of sub-common electrodes 231 are formed in a rectangular shape in a one-to-one correspondence to the plurality of pixel electrodes 171, with the liquid crystal layer 300 interposed therebetween. The sub-common electrodes 231 which are supplied with the common voltage from the common voltage line 236 via the connecting parts 233 directly apply a voltage to the liquid crystal layer 300 along with the pixel electrodes 171. Accordingly, the orientation of the crystals in the liquid crystal layer 300 is varied depending on a voltage difference generated between the pixel electrodes 171 and the sub-common electrodes 231.

The sub-common electrodes 231, each having the common electrode domain-defining member 232, are separated from each other with the common voltage lines 236 as boundaries. Along with the pixel electrode domain-defining member 173 of the pixel electrodes 171, the common electrode domain-defining member 232 divides the liquid crystal layer 300 into a plurality of domains to widen a viewing angle. FIG. 1 shows the common electrode domain-defining-member 232 indicated by dotted lines in the layout of the TFT substrate 100 in order to represent a positional relation with the pixel electrode domain-defining member 173.

As will be appreciated by reference to FIG. 2, common voltage lines 236 are formed in a lattice pattern between the sub-common electrodes 231 and apply the common voltage from a common voltage supply source (not shown), which is provided outside of a display region in which an image is displayed, to the sub-common electrodes 231 through the connecting parts 233.

The connecting parts 233 interconnect the sub-common electrodes 231 by connecting a portion of four corners of the sub-common electrodes 231 to a portion of the common voltage lines 236. Since the common voltage applied from the common voltage lines 236 is delivered to the sub-common electrodes 231 through the connecting parts 233, the sub-common electrodes 231 are supplied with the same common voltage, unlike the pixel electrodes 171, which are supplied with different pixel voltages.

Gaps 237 are formed in spaces having no connecting parts 233 between the sub-common electrodes 231 and the common voltage lines 236. If the connecting parts 233 are severed, the gaps 237 make the sub-common electrodes 231 electrically isolated from the common voltage lines 236. Accordingly, the associated sub-common electrode 231 is electrically isolated from the common voltage lines 236 and is not supplied with the common voltage.

The common voltage portions 231, 233 and 236 are made of a transparent conductive material such as ITO or IZO. It is preferable, but not necessary, that the common voltage wiring portions 231, 233 and 236 are at the same layer by a photolithographic process.

The composition of liquid crystal layer 300 located between the TFT substrate 100 and the second or upper substrate 200 may be of the type which provides a vertically aligned (VA) mode of operation.

Polarizing plates (not shown) are attached on the front surface of the upper substrate 200 and on the rear surface of the TFT substrate 100, respectively, with their polarizing axes parallel to each other. Accordingly, the LCD device has a normally black mode in which each pixel displays a black image in the absence of application of the pixel voltage and the common voltage.

In the LCD device as described above according to the first embodiment of the present invention, the sub-common electrodes 231, which are separated from each other by the common voltage lines 236 having a lattice form as boundaries, are electrically interconnected by the connecting parts 233. Accordingly, the sub-common electrodes 231 may be supplied with the same common voltage from the common voltage lines 236 through the connecting parts 233.

In addition, if defective pixels are found when the LCD panel 1 is tested to find any defects, connecting parts 233 corresponding to the defective pixels may be cut by a laser beam so that sub-common electrodes 231 corresponding to the defective pixels are not supplied with the common voltage. Accordingly, in the case of an LCD not requiring high display performance, the LCD panel 1 may be repaired by making defective pixels display only black images. This allows the LCD panel 1 to be repaired more easily, as compared with the conventional defective pixel repair method, in which the backlight unit (not shown) attached to the LCD panel 1 is disassembled from the LCD panel 1, at least one of the source electrode 132 and the drain electrode 133 of the TFT substrate 100 is cut using the laser beam such that the defective pixels are not supplied with the pixel voltage, and the backlight unit is recombined to the LCD panel 1.

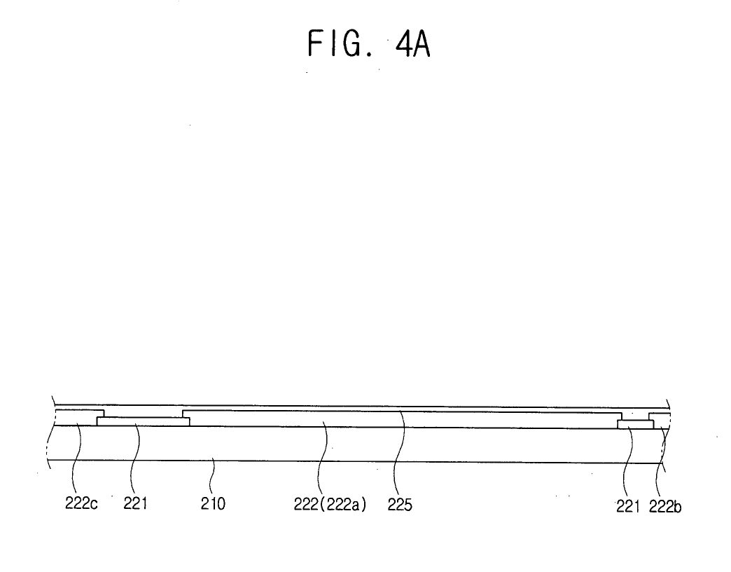

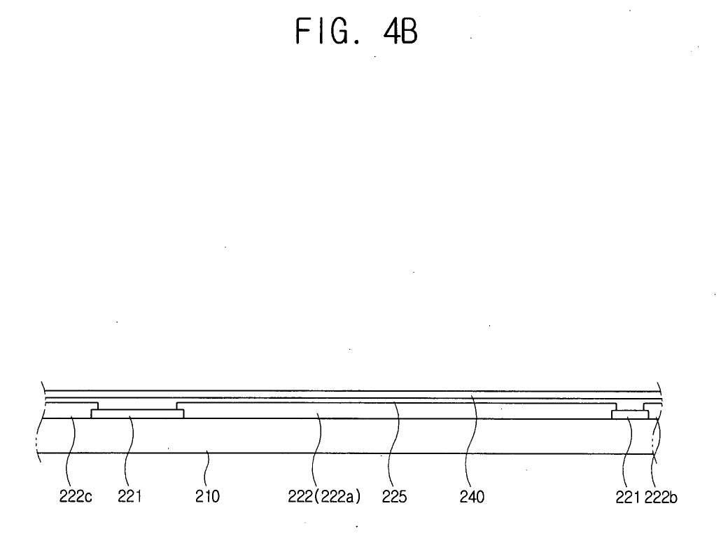

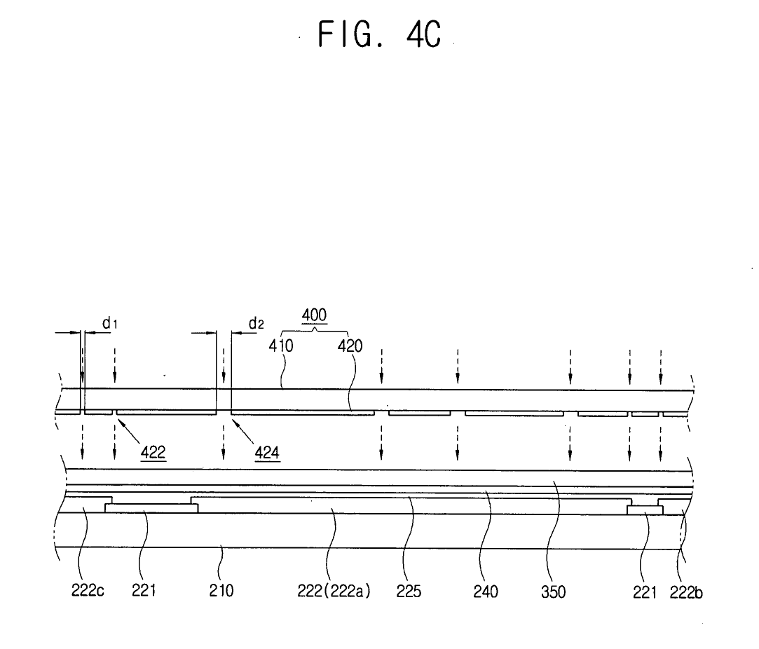

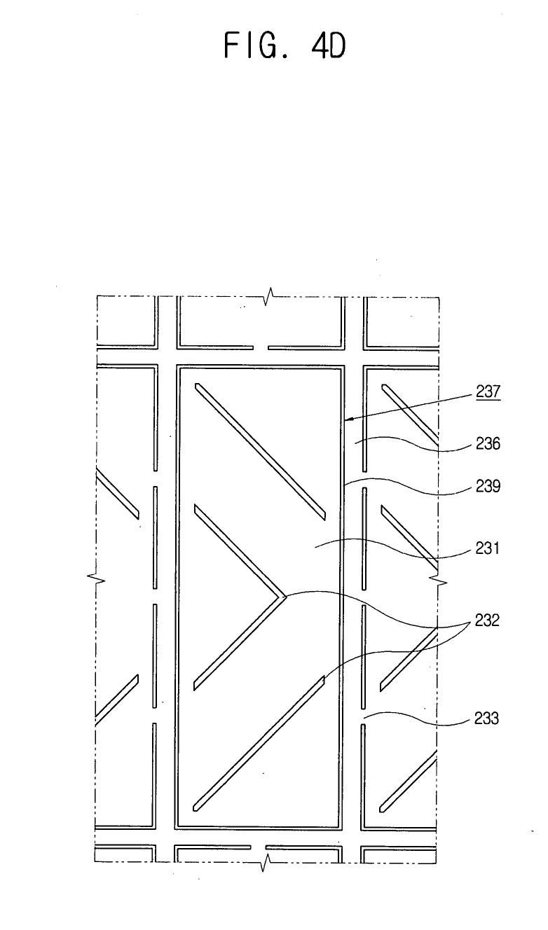

A method for manufacturing the LCD device according to the first embodiment of the present invention is described below. In the manufacturing method of the LCD device according to the first embodiment of the present invention, an operation of providing a TFT substrate on which a plurality of TFTs and pixel electrodes electrically connected to the TFTs are formed is performed according to methods known in the art. Therefore, the following description will be focused on a manufacturing method of an opposite substrate with reference to FIGS. 4A to 4D showing sectional views and a layout for illustrating a method of manufacturing the opposite substrate of the LCD device, respectively, according to the first embodiment of the present invention.

To begin with, as shown in FIG. 4A, the black matricies 221, the color filters 222 and the overcoat layer 225 are formed in order on the second insulating substrate 210.

The black matrices 221 may be made of a photosensitive material that contains black pigment, and are completed through coating, development and baking processes. Next, a red photosensitive organic material is coated on some of the black matrices 221 and a portion of the second insulating substrate 210 on which the black matrices 221 are not formed, and then a red color filter 222a is formed in one pixel through exposure and development processes. Subsequently, a green photosensitive organic material is coated, and then a green color filter 222b is formed in another pixel through exposure and development processes. Similarly, through the same processes, a blue color filter 222c is formed in still another pixel to complete the color filters 222.

After the color filters 222 are completed, the overcoat layer 225 is formed on the color filters 222 to provide a flat surface for the color filters 222 and protect the color filters 222.

Next, as shown in FIG. 4B, a transparent conductive layer 240 typically made of ITO, IZO or the like is deposited on the overcoat layer 225 by a sputtering process or the like.

Next, as shown in FIG. 4C, the common voltage wiring lines 231, 233 and 236 are patterned by a photolithographic process.

First, a photoresist film 350 is formed on the transparent conductive layer 240, and then is exposed using an exposure mask 400. The photoresist film 350 is of a positive type in which an exposed portion is cured and removed when it is developed, and the exposure mask 400 comprises a transparent substrate 410 and opaque films 420 formed on the transparent substrate 410.

The transparent substrate 410 is made of a transparent material such as quartz and passes ultraviolet rays without having an effect on a path along which the ultraviolet rays travel in the exposure process.

The opaque films 420 may be provided as a double layer made of material through which the ultraviolet rays can not pass, such as chrome or chrome oxide.

In the opaque films 420 are formed openings 422 and 424 having widths of d1 and d2, respectively, through which the ultraviolet rays pass in the exposure process to cure the photoresist film 350 in order to form the gaps 237 and the common electrode domain-defining member 232 through later development and etching processes.

After the photoresist film 350 is subjected to the exposure, development and etching processes in order, the sub-common electrodes 231 having the common electrode domain-defining member 232 formed therein and the common voltage lines 236 are formed as shown in FIG. 2. Then, the connecting parts 233 are formed to interconnect the sub-common electrodes 231 and the common voltage lines 236 in remaining portions except the gaps 237 to complete the opposite substrate 200. That is, the sub-common electrode 231, the common voltage lines 236 and the connecting parts 233 are simultaneously formed by the photolithographic process.

Next, the completed TFT substrate 100 and opposite substrate 200 are bonded to each other by a sealant (not shown), and a space formed between the TFT substrate 100 and the opposite substrate 200 is filled with the liquid crystal layer 300 to complete the LCD panel 1 shown in FIG. 3.

Thereafter, the complete LCD panel 1 is assembled to the backlight unit (not shown), and then, is tested to check whether or not it has any defective pixels. The check is performed according to test methods known in the art.

When defective pixels are found in the test for the LCD panel 1, connecting parts 233 connected to sub-common electrodes 231 of the defective pixels are cut to repair the LCD panel 1.

Specifically, when the defective pixels are found, the connecting parts 233 are cut to form a cut portion 239 by irradiating the laser beam on the connecting parts 233, as shown in FIG. 4D, so that the common voltage is not supplied from the common voltage lines 236 to the sub-common electrodes 231 formed on the defective pixels. Accordingly, the sub-common electrodes 231 formed on the defective pixels are completely isolated from the common voltage lines 236 by the gaps 237 and the cut portion 239 to prevent the common voltage from being applied to the sub-common electrodes 231. As a result, in the LCD device having a normally black mode, the repaired defective pixels always display black images.

As described above, in the manufacturing method of the LCD device according to the first embodiment of the present invention, when defective pixels are found as a result of checking on the LCD panel 1 of the LCD device, the connecting parts 233 are easily cut by a laser beam so that the common voltage is not supplied to the sub-common electrodes 231 formed on the defective pixels. Accordingly, the LCD panel 1 not requiring high display performance may be efficiently repaired by making the repaired defective pixels display the black images at all times.

Accordingly, the LCD panel 1 can be repaired more easily, as compared with the conventional defective pixel repairing method in which the backlight unit (not shown) combined to the LCD panel 1 is disassembled from the LCD panel 1, at least one of the source electrode 132 and the drain electrode 133 of the TFT substrate 100 is cut using the laser beam so that the defective pixels are not applied with the pixel voltage, and the backlight unit is reassembled to the LCD panel 1.

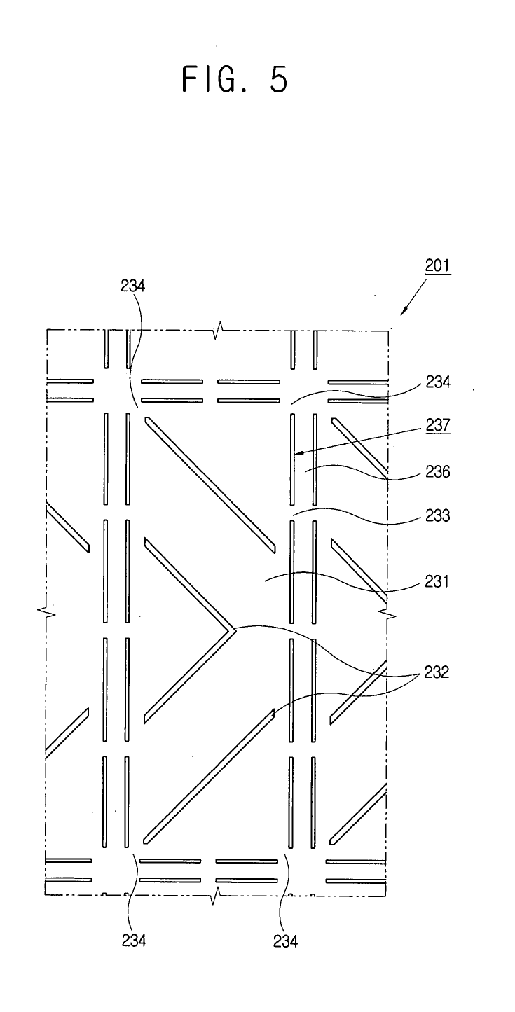

An LCD device according to a second embodiment of the present invention is described below with reference to FIG. 5. FIG. 5 shows a layout of an opposite substrate of an LCD device according to a second embodiment of the present invention.

The LCD device according to the second embodiment has a structure similar to the first embodiment except that in this second embodiment additional connecting parts 234 are positioned in vertexes of the sub-common electrodes 231 of an opposite substrate 201. The additional connecting parts 234 formed in addition to the connecting parts 233 allow the common voltage to be smoothly applied to the sub-common electrodes 231, thereby reducing distortions of electrical signals.

A manufacturing method of the LCD device according to the second embodiment is the same as that of the LCD device according to the first embodiment except that the former uses an exposure mask 400 having openings 422 (see FIG. 4C) having a different shape in the exposure process.

The LCD device and the manufacturing method thereof according to the second embodiment have the same effect as those according to the first embodiment.

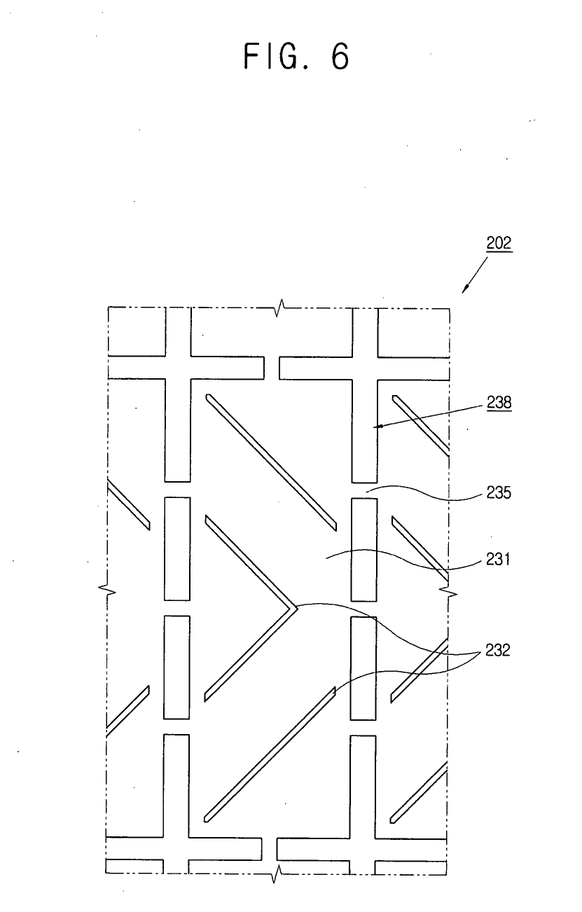

An LCD device according to a third embodiment of the present invention is described below with reference to FIG. 6. FIG. 6 shows a layout of an opposite substrate of an LCD device according to a third embodiment of the present invention.

The LCD device according to the third embodiment has a structure similar to the first embodiment except that, in this third embodiment, a plurality of sub-common electrodes 231 of an opposite substrate 202 are interconnected by the connecting parts 235 formed between gaps 238, and common voltage lines 236 are omitted. One sub-common electrode 231 is applied with the common voltage, which is applied from a common voltage supply source (not shown), via a connecting part 235 from another sub-common electrode 231 close to the common voltage applying part, and applies the common voltage to a different sub-common electrode 231 far from the common voltage supply source via another connecting part 235.

A manufacturing method of the LCD device according to the third embodiment is the same as that of the LCD device according to the first embodiment except that the former uses an exposure mask 400 having openings 422 having a different shape in the exposure process.

The LCD device and the manufacturing method thereof according to the third embodiment have the same effect as those according to the first embodiment.

The above-described embodiments may be modified in various ways. Although the mode of the LCD panel 1 in the first and second embodiments is a patterned vertical alignment (PVA) mode, a VA mode, a super vertical pattern alignment (SPVA) mode or a twisted nematic (TN) mode may be employed for the LCD panel 1. Also, although the color filters 222 are formed on the second insulating substrate 210 of the opposite substrate 200, 201 or 202 in the LCD device according to the above-described embodiments, this is not limiting. For example, the LCD device may have a Color Filter On Array (COA) structure having the TFT substrate 100 including the first insulating substrate 110, TFTs T formed on the first insulating substrate 110, and the color filters 222 formed on the TFTs T, and the opposite substrate 200, 201 or 202 including the second insulating substrate 210 and the common voltage wiring lines 231, 233, 234, 235 and 236 formed on the second insulating substrate 210.

As described above, the present invention provides an LCD device with an LCD panel in which defective pixels are can be deactivated without difficulty, and a method of manufacturing the same.

Although several embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display device comprising:
a first thin film transistor substrate comprising a plurality of thin film transistors formed in a pixel region;
a plurality of pixel electrodes electrically connected to associated ones of the plurality of thin film transistors;
a second substrate positioned in an opposing relationship to the first substrate, the second substrate comprising a common electrode comprised of a plurality of sub-common electrodes, and further wherein the sub-common electrodes are positioned to correspond to associated ones of the pixel electrodes;
a plurality of connecting parts interconnecting the plurality of sub-common electrodes; and
a liquid crystal layer interposed between the first thin film transistor substrate and the second substrate.

2. The liquid crystal display device according to claim 1, wherein the common electrode further comprises a plurality of common voltage line portions and predetermined ones of the connecting parts connect the sub-common electrodes to adjacent common voltage lines.

3. The liquid crystal display device according to claim 2 wherein the common voltage line portions are oriented in a lattice pattern.

4. The liquid crystal display device according to claim 2, wherein the sub-common electrodes, the connecting parts, and the common voltage lines at the same layer.

5. The liquid crystal display device according to claim 1, wherein the sub-common electrodes are rectangularly shaped.

6. The liquid crystal display device according to claim 2 wherein a plurality of connecting parts connect the sub-common electrodes to a common voltage line portion and the connecting parts are positioned in at least one corner of or along a side of the sub-common electrodes.

7. The liquid crystal display device according to claim 1, wherein the composition of liquid crystal layer is of the type that provides operation in a vertically aligned (VA) mode.

8. The liquid crystal display device according to claim 1, wherein the sub-common electrodes and the pixel electrodes comprise domain-defining members.

9. A method for manufacturing a liquid crystal display device, comprising:
providing a first thin film transistor substrate comprising a plurality of thin film transistors and a plurality of pixel electrodes electrically connected to the plurality of thin film transistors, the pixel electrodes being formed in a pixel region;
providing a second substrate including a common electrode comprised of a plurality of sub-common electrodes positioned to correspond to associated ones of the pixel electrodes, and a plurality of connecting parts interconnecting the plurality of sub-common electrodes; and
providing a liquid crystal display panel by bonding the first thin film transistor substrate to the second substrate and filling a space formed between the first thin film transistor substrate and the second substrate with a liquid crystal layer.

10. The method according to claim 9, wherein the sub-common electrodes are formed by:
depositing a transparent conductive layer; and
patterning the transparent conductive layer using a photolithographic process.

11. The method according to claim 10, wherein the common electrode further comprises a plurality of common voltage lines and predetermined ones of the connecting parts connect sub-common electrodes to adjacent common voltage lines portions, the common voltage lines having a lattice shape and being interposed between the sub-common electrodes, are simultaneously formed at the same layer.

12. The method according to claim 11, wherein the sub-common electrodes are rectangularly shaped, and
wherein the connecting parts are connected to at least one of corners or vertexes of the sub-common electrodes or along a side of the sub-common electrodes.

13. The method according to claim 10, wherein the composition of liquid crystal layer is of the type that provides operation in a vertically aligned (VA) mode.

14. The method according to claim 10, further comprising forming domain defining members in the common electrodes.

15. The method according to claim 9, wherein providing the first thin film transistor substrate comprises forming domain defining members in the pixel electrodes.

16. The method according to claim 9, further comprising:
after the providing the liquid crystal display panel,
determining whether the liquid crystal display panel has one or more defective pixels.

17. The method according to claim 16, further comprising:
if one or more defective pixels are found, severing the connecting parts of the sub-common electrodes associated with the one or more defective pixels.

18. The method according to claim 17, wherein the defective pixels in the liquid crystal display panel display only black images.
